(19) United States
(12) Patent Application Publication
(10) Pub. No.: US 2019/0335024 A1
(43) Pub. Date: Oct. 31, 2019

(54) FAILURE DETECTION BY TEST DATA PACKETS OF REDUNDANCY PROTOCOLS

(71) Applicant: HIRSCHMANN AUTOMATION AND CONTROL GMBH, Neckartenzlingen (DE)

(72) Inventors: Rene HUMMEN, Nuertingen (DE); Florian MUECK, Filderstadt (DE); Stephan KEHRER, Dusslingen (DE); Martin WENDT, Bempflingen (DE)

(21) Appl. No.: 16/468,424

(22) PCT Filed: Dec. 15, 2017
(86) PCT No.: PCT/EP2017/083105

§ 371 Date: Jun. 11, 2019

(30) Foreign Application Priority Data
Dec. 16, 2016 (DE) 10 2016 124 584.4

(51) Int. Cl. H04L 29/14; H04L 12/26; H04L 12/437

(52) U.S. Cl. CPC H04L 69/40; H04L 43/0823; H04L 43/106; H04L 43/50; H04L 43/067; H04L 12/437

(57) ABSTRACT

The invention relates to a method for operating a network, wherein network devices in the network exchange useful data among each other via at least one transfer medium by the transfer of useful data packets and at least one redundancy protocol is applied in order to reduce a failure risk, wherein said at least one redundancy protocol carries out a transfer of test data packets in order to detect failures in the network, wherein the invention combines known methods of dynamic redundancy protocols with test data packets and the use of frame preemption or time slot methods in three alternatives or methods which are combinable with each other, this considered individually or also in combination with each other thus enabling a significant reduction of the worst case detection time of a failure in the network, and consequently the reduction of the worst case changeover time in case of fault.

The invention relates to a method of operating a network in which devices in the network exchange useful data with one another via at least one transmission medium by transmitting useful data packets and at least one redundancy protocol is applied to reduce a failure risk, wherein this at least one redundancy protocol transmits test data packets in order to detect failures in the network, according to the features of the respective preamble to the two independent patent claims.

Methods for operating a network are known in which devices in the network exchange data with one another and also from and to further devices such as sensors, actuators and the like via at least one transmission medium and at least one redundancy protocol is applied in order to reduce a failure risk, wherein this at least one redundancy protocol performs a cyclical transmission of test data packets in order to detect failures in the network. Networks, in particular Ethernet data networks, form the technological basis, for example, for industrial monitoring and for control networks in assembly lines. A failure or malfunction in these networks is typically associated with a loss of productivity or control reliability or monitoring reliability.

On the one hand, redundancy protocols, such as, for example, the Media Redundancy Protocol (MRP) or the Device Level Ring (DLR), have proven successful in reducing the failure risk. Along with the exchange of useful data (also referred to as productive data) between the network devices and further devices in the network by means of useful data packets (also referred to as frames), these redundancy protocols typically require the cyclical transmission of test data packets (also referred to as test frames or test packets) in order to detect failures in the network. Depending on the data volume that the network devices exchange with one another and possibly with the further devices in the network also, and the associated utilization of the at least one transmission medium due to the transmitted useful data packets, the transmission of test data packets can, however, be significantly delayed, which has a negative impact on the worst-case switchover time for switching to redundant network paths in the event of a fault.

On the other hand, the use of frame preemption in accordance with IEEE 802.3br and IEEE 802.1Qbu enables an interruption of the transmission of other data (useful data) in order to thus improve latency for specific traffic classes of the useful data packets.

In accordance with IEEE 802.3bv, it is known to define communication cycles and access to the transmission medium by means of a Time Division Multiple Access (TDMA) method on the basis of Class of Service (CoS) priorities in a Virtual Local Area Network (VLAN) header of Ethernet frames in order to thus implement hard real-time requirements with small latencies and deviations (jitter).

The test data packets of a redundancy protocol normally compete with other data (useful data) during transmission for access to the at least one transmission medium (for example data line, radiocommunication path or the like; in the case of Ethernet applications, particularly line-connected). With increasing use of the available bandwidth and with an increasing number of network devices in the network, particularly in a ring network, the useful data can increasingly result in delays in the forwarding of test data packets. The worst-case detection and switchover times of redundancy protocols with test data packets therefore result from the maximum delay in the forwarding of a test frame on each network device.

The object of the invention is therefore to provide a method of operating a network with which the disadvantages outlined above are avoided. In particular, the time in which a switchover to a different transmission path is intended to take place if an interruption of the at least one transmission medium has been established is intended to be reduced.

This object is achieved by the features of the independent patent claims.

The present invention combines known methods of dynamic redundancy protocols with test data packets and the use of frame preemption or time slot methods in three alternative ways or in three ways that are combinable with one another. Considered on their own or in combination with one another, this in each case enables a significant reduction in the worst-case detection time for a failure in the network and thereby the reduction of the worst-case switchover time in the event of a fault.

In ring networks, for example, the MRP or DLR redundancy protocols have proven successful in reducing the failure risk. Here, a network device configured as a ringmaster monitors the network by regularly sending test data packets through the ring. The test data packets are received and forwarded by each network device participating in the redundancy protocol until they return to the ringmaster. If the test data packets are absent, a failure has occurred in the ring network and an alternative transmission path is activated.

According to a first solution, it is provided according to the invention that the transmission of a useful data packet is interrupted and, instead of the further transmission of this useful data packet, a test data packet is transmitted and only thereafter is the transmission of the remaining useful data packet carried out.

Through the use of frame preemption, the test data packets can be treated by redundancy protocols as express data and the transmission of the useful data packets can be interrupted. This interruption enables the prioritized transmission of the test data packets, even if the transmission of a useful data packet has already started. At the end of the transmission of the test data packet, the transmission of the useful data packets is resumed and completed.

Through the interruption of the useful data transmission and the prioritized forwarding of the test data packets, the dwell time of the test data packets in the network devices participating in the redundancy protocol is reduced to a minimum defined by the frame preemption mechanism. This results in an independency of the dwell times of the test data packets from the length of the useful data and thereby in a significant reduction in the worst-case detection and switchover times in the event of a fault.

According to a first alternative of a second solution, it is provided according to the invention that a predefinable time range is reserved for the transmission of test data packets, wherein no useful data packets (regardless of the traffic class or the priority assigned to them) are transmitted within the predefinable time range. A predefined time range that is at least so long that the test data packet can be transmitted within the predefined time range is therefore always available for the transmission of a test data packet. It is also conceivable to select the reserved time for the transmission of test data packets as longer than is required for the actual transmission. In this case, it is ensured that the test data packets with the highest priority and ranking are transmitted prior to the transmission of useful data packets. However, if the predefined time range is longer than the time required for the transmission of a test data packet, the available bandwidth is not optimally utilized as a result, since time is still available within the predefined time range (time slot) following the transmission of a test data packet to transmit useful data packets, in particular lower-priority useful data packets.

According to a second alternative of the second solution, it is therefore provided according to the invention that a predefinable time range is reserved for the transmission of test data packets, wherein the useful data can continue to be transmitted within the predefinable time range and the test data packets are transmitted with a higher transmission priority compared with the useful data packets. In such a case, if time is still available within this time slot after the prioritized transmission of a test data packet within the predefined time range, useful data packets, in particular lower-priority useful data packets or useful data packets that are placed in a queue, can also be transmitted within this time slot. This means that the bandwidth can be optimally utilized and it is not necessary to wait for the expiry of the predefined time range before further useful data packets can be transmitted.

In one embodiment, it is provided for this purpose that a test data packet is first transmitted by the network devices and only thereafter does at least one network device start to transmit a useful data packet.

Since no useful data packets are transmitted within the predefinable time range (also referred to as a time window or time slot), it is advantageously ensured that the useful data packets can cause no effect or delay whatsoever for the transmission of the test data packets.

With the use of time slot methods, such as, for example, IEEE 802.1Qbv, the delay in the forwarding of a test data packet (test frame) on a network device can even be completely eliminated due to a useful data packet (useful data frame) already in the process of being transmitted. Test data packets are assigned via detectable characteristics of these packets to a class, referred to as a Traffic Class, for which a predefinable time slot is then configured by means of time slot methods, such as IEEE 802.1Qbv. The test data packets are then transmitted in a prioritized manner in a time slot of this type, either within one class and/or encompassing multiple classes. The advantage of this solution therefore consists in the optimization of the worst-case detection and switchover times and therefore in the use of time slot methods, such as the aforementioned “Enhancements for Scheduled Traffic” (IEEE 802.1Qbv), in order to enable the transmission time of the test data packets on the ring through dedicated time slots without additional waiting time in the forwarding network device. A predefinable portion of the available bandwidth of the network capacity is thus reserved for test frames (test data packets). For an optimum use of the failure detection time period, the ringmaster transmits the test frames synchronized with the start of the time slot provided for test frames.

In one development of the invention, the generation of the test data packets in the network device that is configured as the master is temporally linked to the opening of the time slot provided for the test data packets. Optimum use is thereby made of the time window for the transmission of the test data packet.

Due to the length independency, in contrast to the known prior art, the use of jumbo frames (i.e. oversized data packets) is similarly possible without adversely affecting the worst-case detection and switchover times.

Finally, the invention is not restricted to ring redundancy protocols, but extends independently from the topology of the network over redundancy protocols that are based on the use of test data packets.

According to the invention, the detection of a failure (interruption of the transmission for whatever reason, such as, for example, cable break, removed or defective connector, power failure in a network device or the like) is advantageously always quickly detected due to the minimized waiting time of test data packets on network devices, so that the time until a detection of a failure is minimized.

An example calculation can illustrate the contribution of the invention. In DIN EN 62439-2:2010-09 (MRP) Chapter 9.5.4, a worst-case calculation is performed for 50 ring participants, with the result of a switchover time of 26.2 ms. If the value for smallest framelets with frame preemption of 64 byte/5.12 μs is used for TQueue, the result is only 14.5 ms. Through the use of the time slot method, TQueue can be reduced to 0 μs, in which case the switchover time is then only 14.0 ms.

The two solutions outlined in general above are described in detail below with reference to the figures on the basis of an example embodiment.

FIG. 1 shows by way of example a network in the form of a ring topology in which four network devices NWG are present. These network devices NWG are interconnected via a line-connected transmission medium, in particular a data line DL, for the purpose of transmitting data. For the application of a redundancy protocol, such as, for example, the application of the Media Redundancy Protocol (MRP) or the Device Level Ring (DLR), it is assumed that one network device is configured as the master (denoted as M in FIG. 1), while the remaining network devices NWG are configured as clients (denoted as R1, R2 and R3 in FIG. 1). If a fault is identified within the network by means of the transmitted test data packets, a switchover to other transmission sections can be performed in a manner known per se for the transmission of the useful data (and also the test data packets), so that a different network device NWG that had hitherto been configured as a client can also perform the function of the master on the basis of the known redundancy protocols. These switchover mechanisms that are also applied here are essentially known, so that a detailed description is not required at this point.

FIG. 1 shows four network devices NWG by way of example, wherein often more than four network devices NWG, less frequently fewer than four network devices NWG, are present in practice.

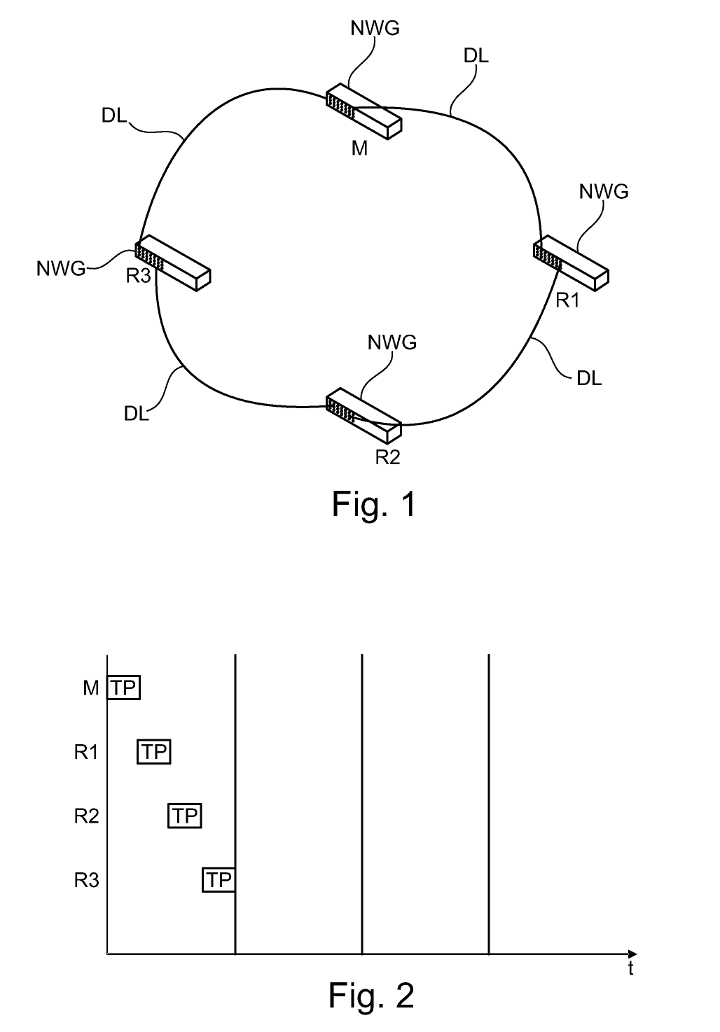

FIG. 2 shows the progression of test data packets TP within the ring topology according to FIG. 1. The network device NWG that is configured as the master M transmits a test data packet TP to the next network device NWG (here the client R1). From there, this client R1 transmits the test data packet to the next network device NWG, i.e. the next client R2. If the test data packet TP has been received here, it is forwarded to the next network device NWG, i.e. the client R3, which can forward the received test data packet to the master M.

It should be noted at this point that this procedure is described on the basis of a ring topology. However, the invention is not restricted to ring topologies and can be applied equally to other network topologies, such as e.g. line topologies.

FIG. 2 shows the progression of test data packets through the ring network in the ideal case, which does not yet take account of an exchange of useful data in the form of useful data packets. This is therefore a theoretical ideal case that will not occur in practice, since it does not take account of the transmission of useful data packets within the network.

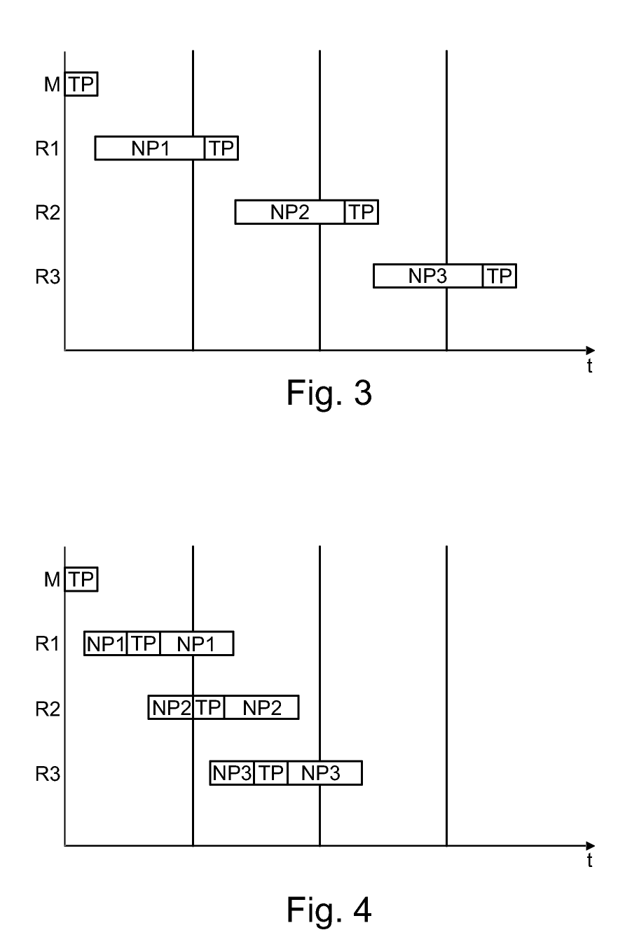

FIG. 3 takes account of the case in which not only the test data packets are transmitted via the network devices, but also useful data packets are transmitted between and beyond the individual network devices.

FIG. 3 shows the worst case in this transmission of test data packets and useful data packets, wherein the master M transmits a test data packet. Since the client R1 is processing, in particular is transmitting, a useful data packet NP1, the test data packet TP received from the master M cannot be forwarded until the useful data packet NP1 has been completely transmitted. The same applies to the further network devices R2 and R3, so that the forwarding of the test data packet by the further network devices NWG (here the clients R1 and R3) is delayed in each case due to the processing or transmission of the further useful data packets NP2 and NP3.

In the first solution according to the invention, as shown in FIG. 4, the transmission of the useful data packet is interrupted and a test data packet is transmitted instead of the further transmission of this useful data packet and only thereafter is the transmission of the remaining useful data packet performed. With regard to FIG. 4, this means that the first network device (the master M that does not necessarily have to be the first network device, but may be any other network device), transmits a first data packet and the next network device NWG, here the client R1, starts to transmit a useful data packet 1. According to the invention, however, there is no waiting until the useful data packet NP1 has been completely transmitted by the network device R1, but the transmission of this useful data packet NP1 is interrupted in order to instigate the transmission of the test data packet TP by the network device R1. After this has taken place, the remaining useful data packet NP1 (in FIG. 4, the larger part of NP1) is transmitted.

The same procedure takes place with the network device R2 that has already started to transmit a useful data packet NP2 when it receives the test data packet. If the test data packet TP of the network device R1 has been received by the network device R2, the transmission of the useful data packet NP2 that has already started is interrupted and the test data packet TP is transmitted by the network device R2. After this has taken place, the remaining part of the useful data packet NP2 (by way of example the larger part here also) is further transmitted.

This continues with the further network device R3, so that the first solution approach according to the invention illustrates the considerable reduction in the transmission time of a test data packet TP on the ring network compared with the worst case that is shown in FIG. 3.

The length or size of the respective useful data packet NP1, NP2 and NP3 according to FIG. 4 is determined by the time at which the respective data packet TP has been received on the respective network device. This means that the length or size of the useful data packet NP1, NP2 and NP3 in front of and behind the test data packet TP may also be of the same size or may differ from the illustration shown in FIG. 4.

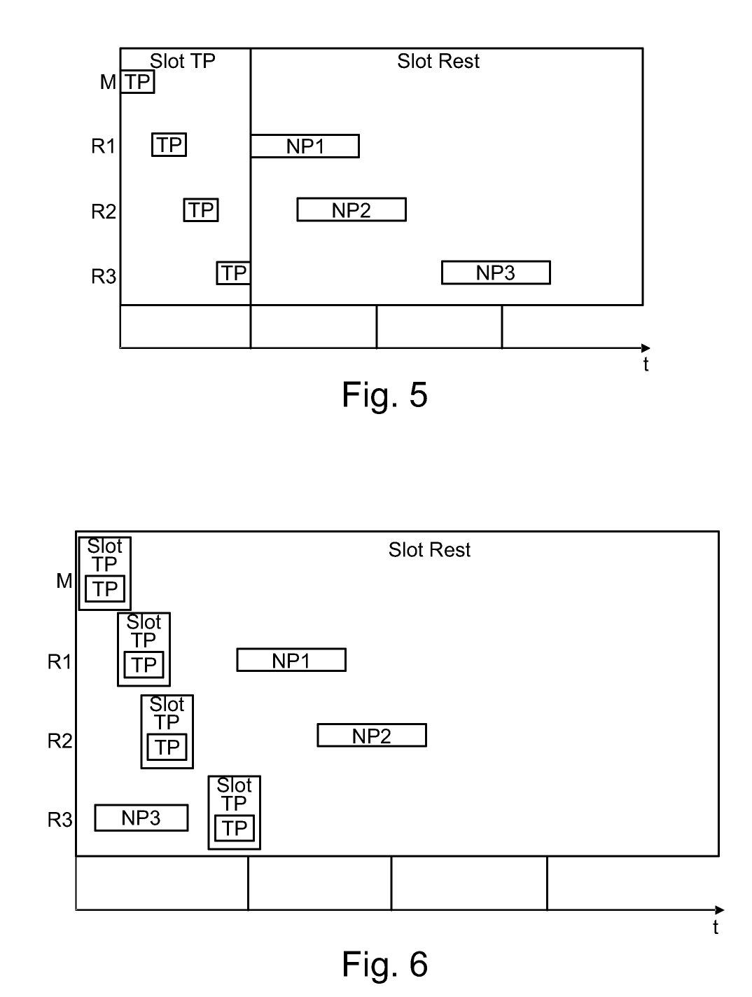

FIG. 5 shows an alternative of the second solution according to the invention with reference to an embodiment in which a predefinable time range (time slot Slot TP) is reserved for all network devices and a test data packet is first transmitted by the network devices and only thereafter does at least one network device start to transmit a useful data packet. With regard to FIG. 5, this means that a time slot is reserved for the test data packets (Slot TP), so that a test data packet is always transmitted via the network before the transmission of useful data packets is started.

In the example case according to FIG. 5, the master M therefore transmits its test data packet TP within the reserved time slot, said test data packet being received and forwarded by the client R1. The same applies to the test data packet TP that is transmitted by the client R1 and is received by the client R2, in exactly the same way as the test data packet TP that is transmitted by the client R2 and is received by the client R3. The at least one further network device, in this example case the client R1, cannot transmit its useful data packet NP1 until the test data packets TP are transmitted within the time slot reserved for them. The same applies to the two further network devices R1 and R3 also, which cannot transmit their useful data packets NP2 and NP3 until the test data packet TP has been transmitted within the reserved time slot (Slot TP). No useful data packets can therefore be transmitted during the time period reserved by the time slot, even if the test data packet has already been completely transmitted. The useful data packets must therefore wait until the time window assigned to them opens.

FIG. 6 shows the general case of the second solution according to the invention. In this case, a predefinable time range is reserved for the transmission of test data packets, wherein no useful data packets are transmitted within the predefinable time range. This may therefore involve at least two or more time slots (as opposed to one time slot for all network devices) and also different time slots on different network devices in order to take account of path and processing latencies.

FIG. 6 therefore shows that a reserved time slot (Slot TP) in which the test data packet TP can be transmitted is assigned to each network device (M, R1 to R3). The transmission of the useful data packets is possible at any time before and after this reserved time slot. This example embodiment thus shows that the network device that is configured as the master M transmits a test data packet to the client R1 in a time slot reserved for this purpose. The network device configured as the master can receive and transmit useful data packets before and after the reserved time slot. The client R1 for its part has reserved a time slot within which it can forward the received test data packet TP. FIG. 6 shows that the useful data packet NP1 of the client R1 is transmitted after the reserved time slot for the test data packet TP. The same applies to the client R2, and the client R3 has also reserved a time slot for the test data packet TP. However, this client R3 can in turn transmit its useful data packet NP3 even before the reserved time slot.

The time slots reserved by the respective network devices are identical (i.e. have the same temporal length). Alternatively, different time slots can be reserved for the test data packets for each network device or for each network device group (to be set in the network device through configuration). It must be ensured here that the predefinable time range (time slot) has a minimum temporal length that is sufficient for the reliable and complete transmission of a test data packet.

In this alternative of the second solution according to the invention, the test data packets are therefore preferably transmitted in the reserved time slot of the network devices, so that either the transmission of a network data packet must take place before the reserved time slot or takes place only after the transmission of the test data packet within its reserved time slot. It is thus advantageously ensured that, whenever a test data packet is pending for transmission, no useful data packet is present in the transmission and hinders the transmission of the test data packet.

This second solution also results in a significantly faster transmission of the test data packets (particularly in comparison with FIG. 3), so that, in the event of a fault, a substantially faster response to such a fault event and a faster switchover are enabled.

In the second solution according to the invention (in one of the two or in both alternatives), the test data packets, exactly as in the first solution according to the invention, are thus treated as express data, wherein the useful data packets are interrupted in the first solution and the test data packets have the highest priority and therefore have a “clear run” on the network in the second solution.

1. A method of operating a network comprising the steps of:
devices in the network exchanging data with one another via at least one transmission medium by transmitting useful data packets; and
applying at least one redundancy protocol in order to reduce a failure risk;
transmitting with at least one redundancy protocol test data packets in order to detect failures in the network; characterized in that
interrupting the transmission of a useful data packet; and, instead of the further transmission of this useful data packet,
transmitting a test data packet and only thereafter completing the transmission of the remaining useful data packet.

2. A method of operating a network comprising the steps of:
devices in the network exchanging data with one another via at least one transmission medium by transmitting useful data packets;
applying at least one redundancy protocol in order to reduce a failure risk;
transmitting with at least one redundancy protocol test data packets in order to detect failures in the network;
reserving a predefinable time range for the transmission of test data packets;
transmitting no useful data packets within the predefinable time range, or
reserving a predefinable time range for the transmission of test data packets;
continuing the transmission of useful data can continue within the predefinable time rage and transmitting the test data packets are with a higher transmission priority compared to the useful data packets.

3. The method of operating a network according to claim 2, further comprising the steps of:
interrupting the transmission of a useful data packet; and, instead of the further transmission of this useful data packet,
transmitting a test data packet and only thereafter completing the transmission of the remaining useful data packet.

4. The method of operating a network according to claim 2, further comprising the steps of:
first transmitting a test data packet by the network devices and only thereafter
at least one network device starts to transmit a useful data packet.

5. The method of operating a network according to claim 2, further comprising the step of:
temporally linking the generation of the test data packets in the network device that is configured as the master to the opening of the time slot provided for test data packets.

6. The method of operating a network according to claim 1, further comprising the step of:
giving test data packets a higher priority in order to define the redundancy state, and
thereby reducing waiting times for test data packets on network devices to a minimum that is necessary until a lower-priority subframe has been interrupted.
